(19) United States
(12) Patent Application Publication
(10) Pub. No.: US 2011/0244207 A1
(43) Pub. Date: Oct. 6, 2011

(54) THIN GLASS PLATE AND METHOD OF MANUFACTURING THE SAME

(76) Inventors: Tatsuya TAKAYA, Otsu-shi (JP); Keiji Takagi, Otsu-shi (JP); Michiharu Eta, Otsu-shi (JP); Yuji Iwama, Otsu-shi (JP)

(21) Appl. No.: 13/039,736

(22) Filed: Mar. 3, 2011

(30) Foreign Application Priority Data
Mar. 30, 2010 (JP) 2010-079009

(51) Int. Cl. B32B 5/00; C03B 17/06

(52) U.S. Cl. 428/220; 65/90

(57) ABSTRACT

Provided is a method of manufacturing a thin glass plate, including: pouring a molten glass (Gm) into an overflow groove (2) formed in a top of a forming body (1); allowing the molten glass (Gm) which is overflown from the overflow groove (2) over both sides of the overflow groove (2) to flow downward along an outer surface portion (4) having a substantially wedge-like shape of the forming body (1); and fusing and integrating the molten glass at a lower end of the forming body (1), thereby forming a thin glass plate (G) having a thickness equal to or less than 500 μm. In doing so, in order to suppress a releasing amount of a primary zircon crystal grain included in a surface of the forming body (1), a viscosity of the molten glass (Gm) flowing on an outer surface of the forming body (1) is controlled to be equal to or higher than 3,000 dPa·s and equal to or lower than 30,000 dPa·s throughout the outer surface of the forming body (1).

### TECHNICAL FIELD

The present invention relates to an improvement in a technology for manufacturing a thin glass plate by an overflow downdraw method.

### BACKGROUND ART

As is well known, as represented by a glass substrate for a flat panel display (FPD) such as a liquid crystal display, a plasma display, or an organic light-emitting diode (OLED) display, thin glass plates utilized in various fields are actually required to satisfy a rigorous product quality requirement for surface defects and waviness.

As a method of manufacturing a thin glass plate of this kind, an overflow downdraw method may be utilized for obtaining a glass surface which is smooth and free of defects.

This manufacturing method includes: pouring a molten glass into an overflow groove in a top of a forming body; allowing the molten glass which is overflown over both sides from the overflow groove to flow downward through a top planar portion of the forming body and along an outer surface portion having a substantially wedge-like shape of the forming body; and fusing and integrating the molten glass at a lower end of the forming body, thereby continuously forming a single thin glass plate (for example, see Patent Literature 1).

This manufacturing method is characterized in that both front and back surfaces of the thin glass plate thus formed are formed in a forming process without coming into contact with any area of the forming body, and hence a fire polished surface with extremely high flatness and smoothness and no defects such as flaws can be obtained.

Thus, for example, the glass substrate for the liquid crystal display having a thickness of about 700 μm, which is currently the mainstream, is manufactured by this manufacturing method, it is possible to ensure a surface accuracy high enough to satisfy the required product quality.

The forming body utilized in the overflow downdraw method described above is brought into contact with a hot molten glass, and hence high heat resistance is required. Therefore, the forming body made of dense zircon having high heat resistance is often used.

Meanwhile, there is a problem in that, when the thin glass plate is formed by using the dense zircon forming body of this kind, as the thickness of the thin glass plate becomes smaller, a thickness deviation occurs in the thin glass plate.

Note that, Patent Literature 2 discloses an approach of adjusting a temperature of the molten glass flowing on an outer surface of the forming body in order to prevent the occurrence of defects caused by zircon in the glass plate, when the forming body (isopipe) made of a pressed zircon refractory is used to form a glass plate by the overflow downdraw method.

The defects in question in Patent Literature 2 are zircon crystal grains resulting from precipitation and growth of zirconia, which is dispersed into the molten glass, from the molten glass at the lower end of the forming body, that is, secondary zircon crystal grains.

### CITATION LIST

### Patent Literature

[PTL 1] Japanese Patent Application Laid-open No. 2006-298736
[PTL 2] Japanese Patent Translation Publication No. 2005-514302

### SUMMARY OF INVENTION

### Technical Problem

However, even if the occurrence of the above-mentioned secondary zircon crystal grain is suppressed, a thickness deviation of the thin glass plate still occurs, and hence it has been desired to identify the cause of the occurrence of the thickness deviation of the thin glass plate.

Therefore, as a result of an exhaustive study by the inventors of the present invention, it has been found that the cause of the occurrence of the thickness deviation of the thin glass plate results not from the secondary zircon crystal grain, but from countless numbers of primary zircon crystal grains already present on a surface of a forming body made of dense zircon at the time of manufacturing the forming body. The primary zircon crystal grain is not a zircon crystal grain (secondary zircon crystal grain) resulting from precipitation and growth of zirconia, which is dispersed into the molten glass from the forming body, from the molten glass, but a zircon crystal grain formed from release of a zircon grain included in a dense zircon refractory.

More specifically, even the dense zircon forming body cannot avoid reaction with the molten glass if the thin glass plates are continuously manufactured for a long period of time. As a result, corrosion of the surface of the forming body causes the primary zircon crystal grain to be released from the surface of the forming body. When the primary zircon crystal grain is released in this manner, the primary zircon crystal grain is entrained in the molten glass flowing on the outer surface of the forming body. Then, when the molten glass is fused and integrated at the lower end of the forming body, the primary zircon crystal grain is embedded into a center in a thickness direction of the fused and integrated molten glass (fused portion X illustrated by the dash dotted line of FIGS. 3A and 3B). Therefore, the primary zircon crystal grain remains in an embedded state in the center in the thickness direction of the thin glass plate obtained by cooling the molten glass.

The size of the primary zircon crystal grain is about 5 to 30 μm. Thus, as illustrated in FIG. 3A, when a thin glass plate G has a thickness of about 700 μm, a primary zircon crystal grain 6 is small relative to the thickness of the thin glass plate G, and hence a thickness fluctuation of the thin glass plate G due to the primary zircon crystal grain 6 cannot substantially occur. In contrast to this, as illustrated in FIG. 3B, when the thickness of the thin glass plate G is reduced to be equal to or less than 500 μm, the primary zircon crystal grain 6 is large relative to the thickness of the thin glass plate G, and hence the thickness fluctuation of the thin glass plate G becomes obvious. As a result, a bulged portion 7 caused by the primary zircon crystal grain 6 is formed in the thin glass plate G.

This can be determined from FIG. 4, which shows a relationship between the thickness of the glass plate including the primary zircon crystal grain of 20 μm embedded therein and a height of the bulged portion. In other words, as shown in FIG. 4, as the thickness of the thin glass plate becomes smaller, the height of the bulged portion of the surface of the thin glass plate caused by the primary zircon crystal grain becomes larger. The height of the bulged portion of the surface of the thin glass plate having a thickness of 500 μm becomes as large as 1.0 μm just by embedment of the primary zircon crystal grain of as small as 20 μm. For the thin glass plate having a thickness of 50 μm, which is further reduced in thickness, the height of the bulged portion of the surface of the thin glass plate reaches as large as 6 μm, with the result that the surface thickness deviation becomes problematic in terms of quality.

Thus, for the thin glass plate having a thickness equal to or less than 500 μm, the thickness deviation due to the primary zircon crystal grain is large, with the result that it is difficult to ensure the required product quality. In particular, in the case of a glass substrate for FPD, a rigorous quality requirement is inevitably imposed on flatness of the glass substrate, which has a large influence on image quality of a display. Thus, if the thickness deviation which adversely affects the flatness becomes large due to the primary zircon crystal grain, it is more difficult to ensure the required product quality.

It is a technical object of the present invention to reduce the occurrence of the thickness deviation due to the primary zircon crystal grain as much as possible in the thin glass plate having a thickness equal to or less than 500 μm formed by the overflow downdraw method.

### Solution to Problem

As a result of an exhaustive study by the inventors of the present invention, it has been found that a releasing amount of primary zircon crystal grains included in an outer surface of a forming body is associated with a viscosity of the molten glass flowing on the outer surface of the forming body.

That is, an apparatus according to the present invention, which has been made for achieving the above-mentioned object, is characterized to embody the following method. Specifically, the method of manufacturing a thin glass plate includes: pouring a molten glass into an overflow groove formed in a top of a forming body; allowing the molten glass which is overflown from the overflow groove over both sides of the overflow groove to flow downward along an outer surface portion having a substantially wedge-like shape of the forming body; and fusing and integrating the molten glass at a lower end of the forming body, thereby forming a thin glass plate having a thickness equal to or less than 500 μm, in which a viscosity of the molten glass flowing on the outer surface of the forming body is controlled to be equal to or higher than 3,000 dPa·s and equal to or lower than 30,000 dPa·s throughout the outer surface of the forming body.

According to such a method, the viscosity of the molten glass flowing on the outer surface of the forming body is controlled to be equal to or higher than 3,000 dPa·s throughout the outer surface of the forming body. When the viscosity of the molten glass is increased to such a numerical range and the flow rate is unchanged, the thickness of the molten glass flowing on the outer surface of the forming body is increased, and there is obtained a moderate velocity gradient between the molten glass which comes into contact with the outer surface of the forming body and the surface of the molten glass which does not come into contact with the outer surface of the forming body and forms a free surface. As a result, the flow velocity of the molten glass flowing in the vicinity of the outer surface of the forming body becomes relatively slow, and hence the outer surface of the forming body is less subjected to a force required to release the primary zircon crystal grain from the outer surface of the forming body. Therefore, it is possible to reduce a situation in which the released primary zircon crystal grain is entrained into the molten glass and the primary zircon crystal grain is embedded into the formed thin glass plate. Thus, even when the formed thin glass plate has a thickness equal to or less than 500 μm, sufficient flatness of the glass surface can be ensured. Further, such an effect is particularly useful for the thin glass plate having a thickness equal to or less than 200 μm.

Meanwhile, as the viscosity of the molten glass is increased from 3,000 dPa·s, the releasing amount of the primary zircon crystal grain is decreased for the reason as descried above. However, if the viscosity of the molten glass is excessively increased to be higher than 30,000 dPa·s at the lower end of the forming body, it is difficult to properly fuse (fusion-bond) the molten glass at the lower end of the forming body. Thus, in light of formability, an upper limit value of the viscosity of the molten glass needs to be equal to or lower than 30,000 dPa·s. As long as the upper limit value is not exceeded, the molten glass can be reliably fused and integrated into a thin glass plate.

In the method of manufacturing a thin glass plate, it is preferred that the control of the viscosity of the molten glass be achieved by adjusting at least one of a glass composition of the molten glass and a temperature of the molten glass.

In this way, advantageously, the viscosity of the molten glass can be easily and directly controlled.

In the method of manufacturing a thin glass plate, it is preferred that, in the formed thin glass plate, a number of defects due to a primary zircon crystal grain released from a surface of the forming body be 2 or less per 1 m².

The thin glass plate obtained in this way is preferred because it has a considerably small number of defects due to the primary zircon crystal grain causing a thickness deviation occurring in the thin glass plate. Further, even if a defective portion due to the primary zircon crystal grain is eliminated, a most portion other than the defective portion, that is, a non-defective portion without the primary zircon crystal grain, can be used as a product. As a result, the thin glass plate with high flatness can be manufactured while a high yield is maintained.

A thin glass plate, which has been made for achieving the above-mentioned object, has a thickness equal to or less than 500 μm and is formed by an overflow downdraw method, in which a number of defects due to a primary zircon crystal grain is 2 or less per 1 m².

According to this configuration, the number of defects due to the primary zircon crystal grain is extremely few, and hence the occurrence of the thickness deviation due to the primary zircon crystal grain can be reduced as much as possible. Moreover, even if a portion which includes the primary zircon crystal grain is eliminated, a most portion other than the portion thus eliminated, that is, a non-defective portion without the primary zircon crystal grain, can be used as a product.

In the configuration described above, the thin glass plate is preferably a glass substrate for FPD.

In other words, a glass substrate for FPD is required to satisfy a rigorous product quality in terms of surface flatness, which has a large influence on image quality, and thus the thin glass plate having a small number of defects due to the primary zircon crystal grain is preferred.

### Advantageous Effects of Invention

As described above, according to the present invention, even in the case of a thin glass plate having a thickness equal to or less than 300 μm, which is formed by an overflow downdraw method, the number of defects due to the primary zircon crystal grain can be reliably reduced and a thickness deviation can be reduced as much as possible.

### BRIEF DESCRIPTION OF DRAWINGS

FIG. 1 An enlarged perspective view illustrating a main part of an apparatus for manufacturing a thin glass plate for embodying a method of manufacturing a thin glass plate according to an embodiment of the present invention.

FIG. 2 A cross-sectional view taken along the line A-A of FIG. 1.

FIG. 3A A longitudinal cross-sectional view illustrating the prior art, and illustrating the thin glass plate containing a primary zircon crystal grain and having a relatively large thickness.

FIG. 3B A longitudinal cross-sectional view illustrating the prior art, and illustrating the thin glass plate containing the primary zircon crystal grain and having a relatively small thickness.

FIG. 4 A graph showing a relationship between the thickness of the thin glass plate and a height of a bulged portion of a surface of the thin glass plate.

### DESCRIPTION OF EMBODIMENT

Hereinafter, an embodiment according to the present invention is described with reference to the accompanying drawings.

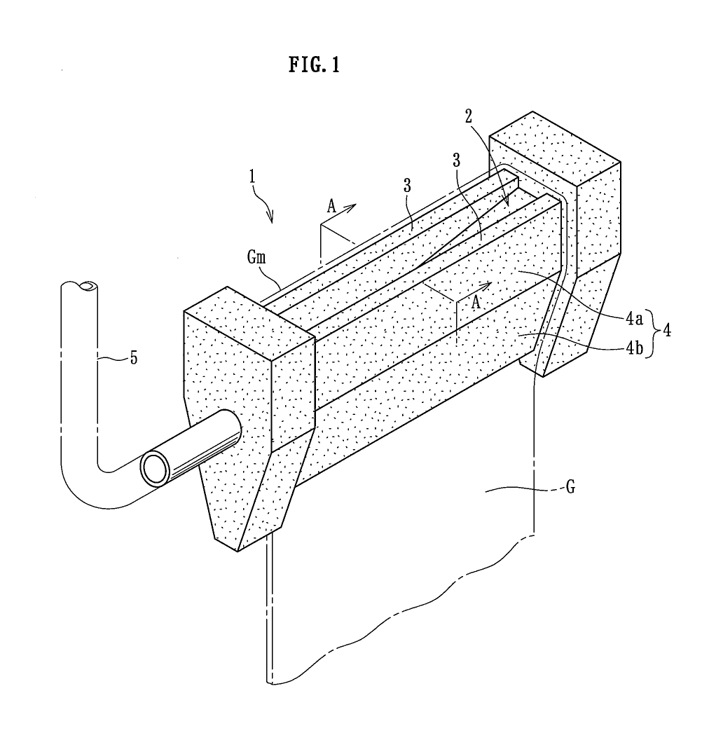

FIG. 1 is an enlarged perspective view illustrating a main part of an apparatus for manufacturing a thin glass plate for embodying a method of manufacturing a thin glass plate according to the embodiment of the present invention. As illustrated in this figure, the apparatus for manufacturing a thin glass plate is used to manufacture a thin glass plate having a thickness equal to or less than 500 μm, and includes a forming body 1 for carrying out an overflow downdraw method.

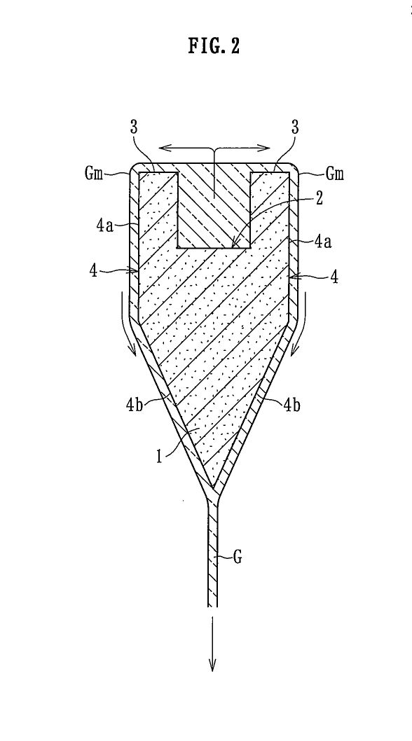

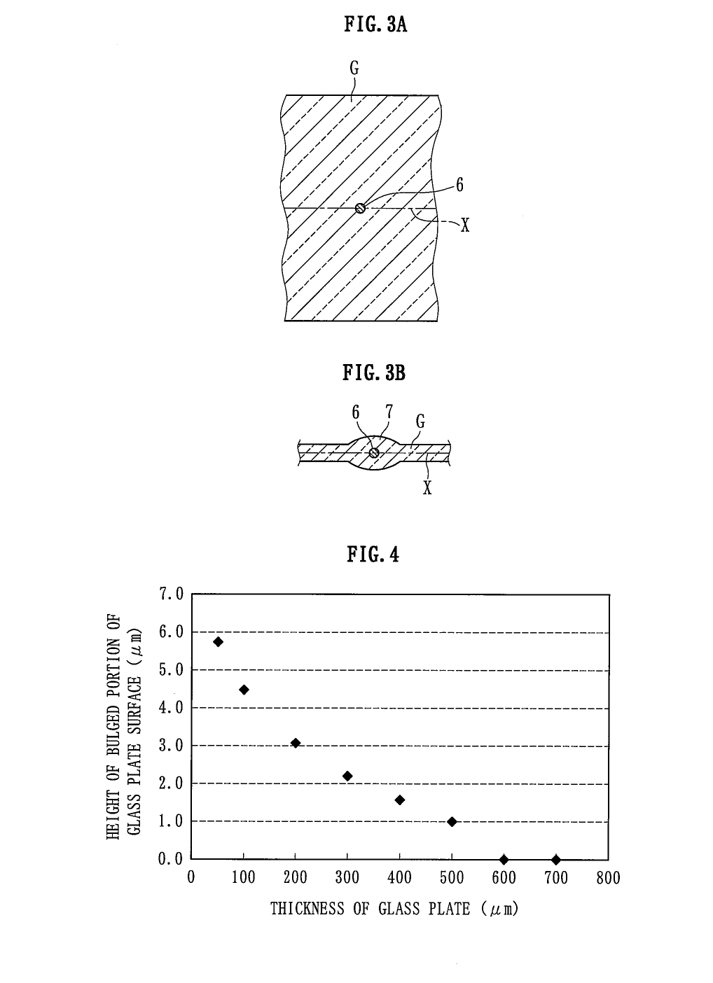

As illustrated in FIGS. 1 and 2, the forming body 1 is elongated along a direction corresponding to a width direction of the thin glass plate to be manufactured, and includes an overflow groove 2 formed along its longitudinal direction in the top thereof and a pair of outer surface portions 4 gradually approaching each other in a downward direction so as to form a substantially wedge-like shape. The forming body 1 preferably contains zircon, and more preferably is made of dense zircon. Specifically, the forming body 1 is produced by processing a dense refractory, the dense refractory being obtained by molding a base composition, which contains mixed grains of sinterable components such as zircon, zircon composite, and titania, using one of isostatic pressing and slip casting or a combination thereof, and then sintering the molded article.

A molten glass Gm is poured into the overflow groove 2 formed in the top of the forming body 1. The molten glass Gm which is overflown over both sides of the overflow groove 2 flows through top planar portions 3 of the forming body 1 extending laterally from both upper end opening edges of the overflow groove 2 and flows downward along both of the outer surface portions 4 having the substantially wedge-like shape of the forming body 1. At this time, the top planar portion 3 functions as a weir for adjusting a flow rate of the molten glass Gm. The molten glass Gm flowing downward along both of the outer surface portions 4 of the forming body 1 is fused and integrated at a portion of a lower end of the forming body 1, which is referred to as a root, and hence a single thin glass plate is continually formed from the molten glass Gm.

In other words, the outer surface of the forming body 1 over which the molten glass Gm flows includes the overflow groove 2, the top planar portions 3, and the outer surface portions 4.

The outer surface portions 4 of the forming body 1 are each configured to include a vertical surface portion 4a and an inclined surface portion 4b vertically connected to each other. An intersection point of the inclined surface portions 4b located below both of the outer surface portions 4 is the portion referred to as the root as described above. Further, the molten glass Gm is supplied into the overflow groove 2 through a supply pipe 5 coupled to one end in the longitudinal direction of the overflow groove 2.

Next, a description is made of a method of manufacturing the thin glass plate by using the apparatus for manufacturing a thin glass plate configured as described above.

As illustrated in FIGS. 1 and 2, first, the molten glass Gm is supplied from the supply pipe 5 into the overflow groove 2, and the molten glass Gm is overflown from the overflow groove 2 through the top planar portions 3 over both sides of the forming body 1. The molten glass Gm, which is overflown over both the sides of the forming body 1, flows downward along both of the outer surface portions 4 and is fused and integrated at a lower end of the forming body 1. The molten glass Gm thus fused and integrated is cooled while being stretched, thereby forming a thin glass plate G.

Further, as a method characteristic of this embodiment, in a series of steps as described above, a viscosity of the molten glass Gm is controlled in order to suppress a releasing amount of the primary zircon crystal grain included in the surface of the forming body 1.

Specifically, the viscosity of the molten glass Gm flowing on the outer surface of the forming body 1 is controlled to be equal to or higher than 3,000 dPa·s throughout the outer surface of the forming body 1.

In this way, when the viscosity of the molten glass Gm is increased to the above-mentioned numerical range, a flow rate of the molten glass Gm flowing in the vicinity of the outer surface of the forming body 1 becomes relatively slow, and hence the outer surface of the forming body 1 is less subjected to a force sufficient to release the primary zircon crystal grain from the outer surface of the forming body 1. Therefore, it is possible to reduce a situation in which the primary zircon crystal grain is entrained in the molten glass Gm and the crystal grain is embedded into the formed thin glass plate. Thus, even when the formed thin glass plate has a thickness equal to or less than 500 μm, sufficient flatness of the glass surface can be ensured.

Further, as the viscosity of the molten glass is increased from 3,000 dPa·s, the releasing amount of the primary zircon crystal grain is decreased for the reason as descried above. However, if the viscosity of the molten glass Gm is excessively increased to be higher than 30,000 dPa·s at the lower end of the forming body 1, it is difficult to properly fuse (fusion-bond) the molten glass Gm at the lower end of the forming body 1.

Consequently, as described above, the viscosity of the molten glass Gm is controlled to be equal to or higher than 3,000 dPa·s throughout the outer surface of the forming body 1 and has a defined upper limit value. Specifically, in light of formability, the upper limit value of the viscosity of the molten glass Gm is controlled to be equal to or lower than 30,000 dPa·s throughout the outer surface of the forming body 1.

The control of the viscosity of the molten glass Gm is achieved by adjusting a temperature of the molten glass Gm or adjusting a glass composition of the molten glass Gm. In other words, when the temperature of the molten glass Gm is increased, the viscosity of the molten glass Gm is decreased, whereas when the temperature of the molten glass Gm is decreased, the viscosity of the molten glass Gm is increased. Further, when the glass composition of the molten glass Gm is adjusted (for example, by addition of metallic oxide), the viscosity of the molten glass Gm is changed even in the case of the same temperature. Note that, the temperature adjustment and the glass composition adjustment can be used in combination.

The temperature adjustment of the molten glass Gm is achieved by increasing and decreasing an output of a heating device disposed around the forming body 1, or changing an arrangement position or number of the heating device. Further, concurrently with the temperature adjustment thus achieved or instead of the temperature adjustment thus achieved, the temperature adjustment of the molten glass Gm may be achieved by changing a heat insulating structure of a heat insulating material or changing the temperature of the molten glass Gm supplied from the supply pipe 5.

Note that, the temperature of the molten glass Gm is measured by a noncontact type temperature measuring device (for example, infrared radiometer) disposed around the forming body 1, and the obtained result of the temperature measurement is fed back to the heating device or the like.

Then, the molten glass Gm is fused and integrated by the forming body 1 while the viscosity of the molten glass Gm is controlled as described above, to thereby form the thin glass plate G. As a result, the thin glass plate in which the number of defects due to the primary zircon crystal grain released from the surface of the forming body 1 is 2 or less per 1 m² can be obtained.

The thin glass plate like this is preferred because it has a considerably small number of defects due to the primary zircon crystal grain adversely affecting a thickness fluctuation. Further, even if a defective portion due to the primary zircon crystal grain is eliminated, a most portion other than the defective portion, that is, a non-defective portion without the primary zircon crystal grain, can be used as a product. Thus, the thin glass plate with high flatness can be manufactured with a high yield. Thus, the non-defective portion can be suitably used as a glass substrate for FPD such as a liquid crystal display.

### EXAMPLES

In order to demonstrate the usefulness of the present invention, a viscosity of a molten glass flowing on an outer surface of a forming body was variously changed, and the number of defects due to a primary zircon crystal grain contained in a thin glass plate to be formed and a transition of formability of the molten glass were tested. Note that, the thin glass plate to be formed had a thickness of 300 μm.

Results of those tests are shown in Table 1. Note that, in Table 1, “formability” and “overall evaluation” were evaluated for each example, using “oo” as good, “o” as fair, “Δ” as poor, and “x” as bad.

TABLE 1

| | | | | | Comparative | Comparative | Comparative |
|---|---|---|---|---|---|---|---|
| | Example 1 | Example 2 | Example 3 | Example 4 | Example 1 | Example 2 | Example 3 |
| Viscosity of | 3,000 | 6,000 | 10,000 | 30,000 | 2,000 | 100,000 | 320,000 |
| molten glass | | | | | | | |
| (dPa · s) | | | | | | | |
| Number of defects | 2.00 | 0.80 | 0.20 | 0.06 | 2.80 | 0.02 | — |
| due to primary | | | | | | | |
| zircon crystal | | | | | | | |
| grain (/m²) | | | | | | | |
| Formability | ∘ | ∘ | ∘ | ∘ | ∘ | Δ | x |
| Overall | ∘ | ∘ | ∘∘ | ∘∘ | x | Δ | x |
| evaluation | | | | | | | |

According to the results shown in Table 1, it can be recognized that in Comparative example 1, in which the viscosity of the molten glass is lower than 3,000 dPa·s throughout the outer surface of the forming body, the number of defects due to the primary zircon crystal grain is 2.8/m², and hence many defects are caused by the release of the primary zircon crystal grain on the surface of the forming body. Further, it can be recognized that in Comparative examples 2 and 3, in which the viscosity of the molten glass is higher than 30,000 dPa·s throughout the outer surface of the forming body, the viscosity of the molten glass at a lower end of the forming body becomes excessively high, with the result that the molten glass at the lower end of the forming body is insufficiently fused, leading to poor formability.

In contrast to this, it can be seen that in Example 1, in which the viscosity of the molten glass is increased from 2,000 dPa·s of Comparative example 1 to 3,000 dPa·s, the number of defects due to the primary zircon crystal grain is improved from 2.8/m² to 2.0/m².

Here, when the number of defects due to the primary zircon crystal grain is 2.0/m², the number of defects due to the primary zircon crystal grain adversely affecting a thickness fluctuation is considerably small. As a result, adverse effect to product quality can be suppressed to a negligible degree. Further, even in the case of a glass substrate for FPD, which is required to satisfy a rigorous product quality, a most portion without the primary zircon crystal grain after eliminating a defective portion due to the primary zircon crystal grain can be used as a product, and hence a high yield can be maintained. Thus, as the number of defects due to the primary zircon crystal grain, 2.0/m² is a kind of threshold for determining whether or not the product quality can be ensured.

Next, in Examples 2 to 4, in which the viscosity of the molten glass is further increased from 3,000 dPa·s, the number of defects due to the primary zircon crystal grain was 0.20 to 0.80/m², which is less than half the number of defects in Example 1, thereby giving a considerably good result.

In addition, in all of Examples 1 to 4, the viscosity of the molten glass throughout the outer surface of the forming body is equal to or lower than 30,000 dPa·s. Thus, the molten glass was prevented from being poorly fused at the lower end of the forming body and capable of being formed in an acceptable state.

Note that, although the formed thin glass plate had a thickness of 300 μm in the above-mentioned tests, changing the thickness does not lead to a significant change in the number of defects due to the primary zircon crystal grain or in the result of formability.

Thus, also from the above-mentioned results, it can be seen that when the thin glass plate having a thickness equal to or less than 500 μm is formed by the overflow downdraw method using the dense zircon forming body, as long as the viscosity of the molten glass is equal to or higher than 3,000 dPa·s and equal to or lower than 30,000 dPa·s throughout the outer surface of the forming body, both the number of defects due to the primary zircon crystal grain and the formability can be maintained in an acceptable state.

### REFERENCE SIGNS LIST

1 forming body
2 overflow groove
3 top planar portion
4 outer surface portion
4a vertical surface portion
4b inclined surface portion
5 supply pipe
6 primary zircon crystal grain
7 bulged portion
G thin glass plate
Gm molten glass

1. A method of manufacturing a thin glass plate, comprising:
pouring a molten glass into an overflow groove formed in a top of a forming body;
allowing the molten glass which is overflown from the overflow groove over both sides of the overflow groove to flow downward along an outer surface portion having a substantially wedge-like shape of the forming body; and
fusing and integrating the molten glass at a lower end of the forming body, thereby forming a thin glass plate having a thickness equal to or less than 500 μm,
wherein a viscosity of the molten glass flowing on an outer surface of the forming body is controlled to be equal to or higher than 3,000 dPa·s and equal to or lower than 30,000 dPa·s throughout the outer surface of the forming body.

2. The method of manufacturing a thin glass plate according to claim 1, wherein the control of the viscosity of the molten glass is achieved by adjusting at least one of a glass composition of the molten glass and a temperature of the molten glass.

3. The method of manufacturing a thin glass plate according to claim 1, wherein in the formed thin glass plate, a number of defects due to a primary zircon crystal grain released from a surface of the forming body is 2 or less per 1 m².

4. A thin glass plate having a thickness equal to or less than 500 μm, which is formed by an overflow downdraw method, wherein a number of defects due to a primary zircon crystal grain is 2 or less per 1 m².

5. The thin glass plate according to claim 4, wherein the thin glass plate comprises a glass substrate for a flat panel display.

6. The method of manufacturing a thin glass plate according to claim 2, wherein in the formed thin glass plate, a number of defects due to a primary zircon crystal grain released from a surface of the forming body is 2 or less per 1 m².
